(19) United States
(12) Patent Application Publication
(10) Pub. No.: US 2003/0145565 A1
(43) Pub. Date: Aug. 7, 2003

(54) Method and device for purifying air contaminated by paint particles

(76) Inventor: Michael Eder, Lienz (AT)

Correspondence Address: Marc D Lorusso, Lorusso & Loud, 440 Commercial Street, Boston, MA, 02109, US

(21) Appl. No.: 10/220,993

(22) PCT Filed: Mar. 6, 2001
(86) PCT No.: PCT/AT01/00062

(30) Foreign Application Priority Data
Mar. 8, 2000 (AT) A 384/2000

(51) Int. Cl. B01D 46/18

(52) U.S. Cl. 55/295; 55/354

(57) ABSTRACT

A method and device for purifying air contaminated by particles. Paint particles in front of a workpiece which is to be painted is suctioned off by means of a suction device. The flow of suctioned air is guided along the outer surface of at least one endlessly circulating loop. At least part of the paint particles contained in the suctioned air is deposited upon the circulating loop.

The invention relates to a method for cleaning air contaminated with paint particles, wherein the paint particles passing by the workpiece to be painted are suctioned by a suction device, and a device for implementing this method.

In painting workpieces, the problem arises that not all the paint particles leaving the sprayer actually impact upon the workpiece and adhere to it. So-called overspray misses the workpiece and disperses into the surrounding air. In many cases it is possible to trap and reclaim some of the paint that misses by arranging a continuous band behind the workpiece to be painted. Such a device is represented, for example, in EP 0 650 398 B 1. In any case, however, additional suction devices are necessary for removing from the air those paint particles impacting neither on the workpiece to be painted nor on the band (where present). Filters have to be arranged in these suction devices that filter the paint particles carried in the air.

The object of the invention is to spare or even to dispense with these filters arranged in the suction device, wherein at the same time the opportunity is provided to reclaim the separated paint particles.

The method according to the invention provides that the flow of suction air is guided along the external band surface of at least one continuously rotating band, wherein at least some of the paint particles contained in the suction air is separated out onto the rotating band.

The device according to the invention provides that the suction device is arranged downstream, behind the area of the continuous band separating out the paint particles from the air.

The suction device attracts the paint particles distributed in the air and accelerates it, wherein guiding of the flow of suction air along the external band surface of the rotating band leads to at least some of the paint particles contained in the suction air being separated out on the rotating band.

In some cases it is possible to arrange the continuous band directly behind the workpiece to be painted. The band can then also directly capture paint particles passing the workpiece to be painted, as is represented in EP 0 650 398 B1.

For reclaiming paint particles, it can be provided that the continuously rotating band passes through a device for removing the paint captured, in which the paint is preferably scraped off.

If the continuously rotating band has the function not only of separating out paint particles separated from the air, but is also used for directly trapping paint particles passing the workpiece to be painted, it is advantageous when separation onto the band occurs at a place that is beyond the capturing device and in front of the place where the paint particles are directly captured.

A particularly advantageous design solution for the device for implementing the method is produced when the continuous band has an area in which it is deflected in an approximately U-shaped manner, and the suction aperture of the suction device is arranged in the base of the trough formed by the deflected part. This makes it possible to transfer paint particles from the extracted air onto rollers that are arranged within the trough and that can be pressed against the outside of the rotating band.

The deposition of the paint particles onto the rollers is improved in that the roller is providing with an electrical earth, and in that a device for electrostatically charging the paint particles carried by the suctioned air is provided.

The transfer of the applied paint from the rollers onto the band is produced by a relative movement between rollers and band. For this reason, it can be provided that the roller is driven independently of the band. The rollers can thus be driven more slowly than the band, or even temporarily rotate in-the opposite direction.

As an alternative, or a supplement to the rollers there is the possibility of deflecting the band at least once in the area where the paint particles are being separated out. The paint particles accelerated by the suction device strike the band because of the deflection and remain adhered to it. It is particularly effective when the band is configured in a zig-zag manner in the area where the paint particles are separated out.

Details of the invention will be explained in more detail hereinafter with reference to the drawings.

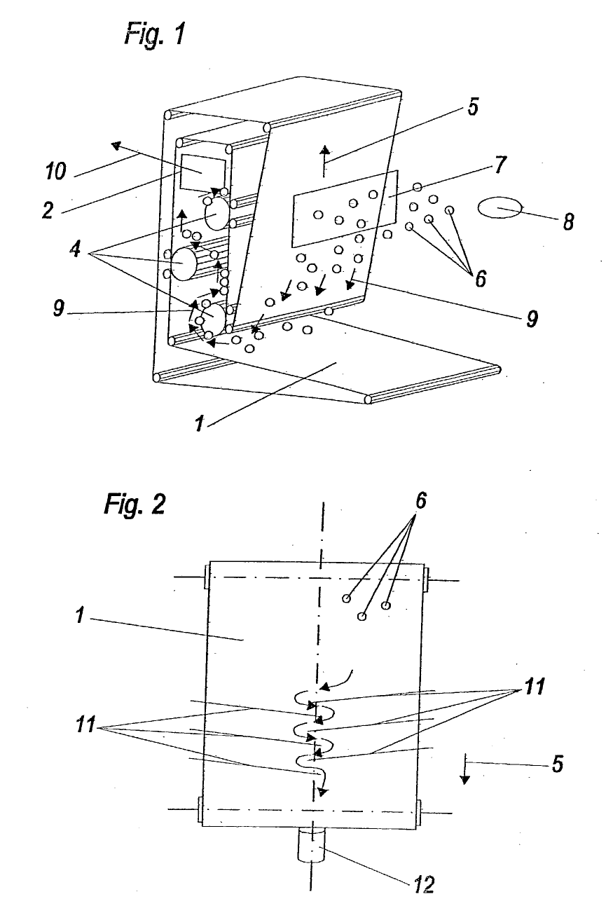

FIG. 1 is an outline diagram of a device according to the invention at an angle from the front,

FIG. 2 shows the rear side of the device of FIG. 1,

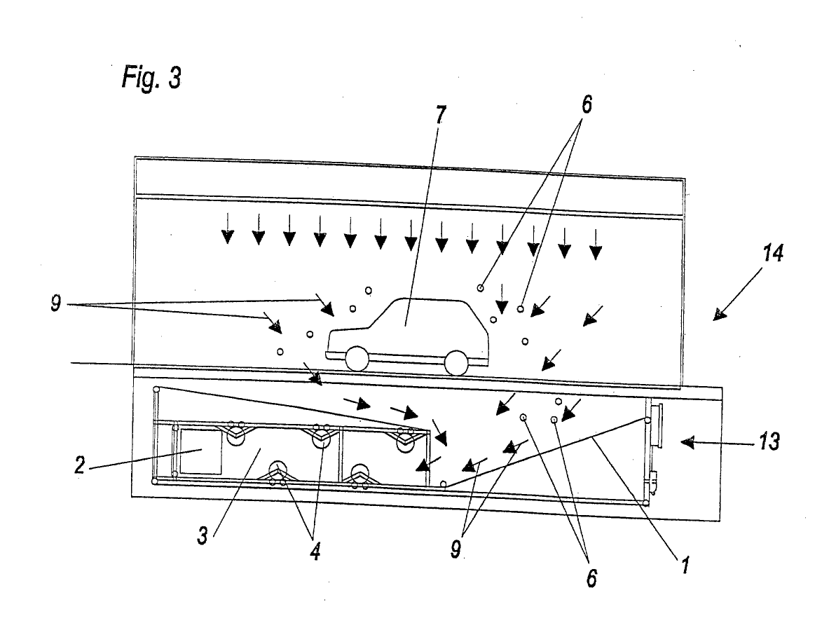

FIG. 3 shows the application of a device according to the invention in a car paint shop booth, and

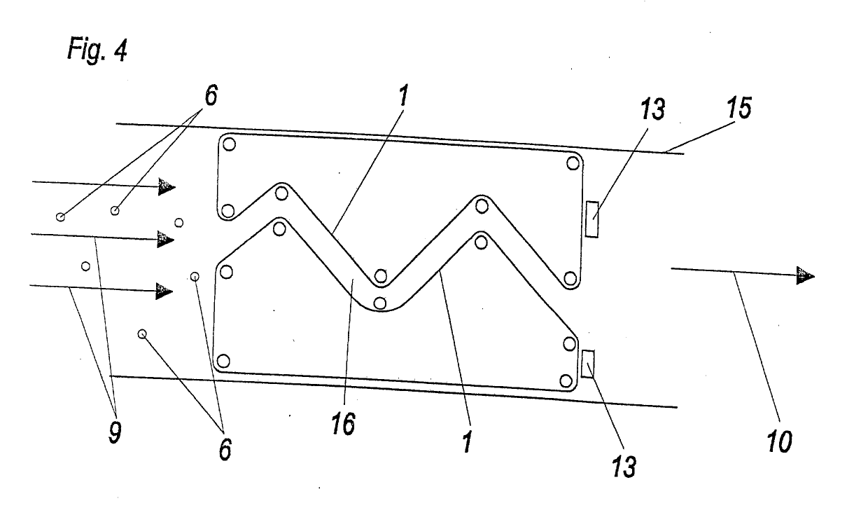

FIG. 4 is an outline representation of an alternative embodiment of the device according to the invention.

The device according to the invention serves to capture and reclaim those paint particles 6 that pass by the workpiece 7 during painting of workpieces using a sprayer 8.

For this purpose, in the device shown in FIGS. 1 and 2 there is shown a continuously rotating band 1 that moves in the direction of the arrow 5. The paint particles 6 impacting upon the band 1 are transported by the band 1 onto the rear side of the device, which is shown in FIG. 2. Here, they are guided by scrapers 11 to the centre of the band and collected in a collection container 12. It would clearly be possible to perform continuous cleaning of the band 1 in other ways.

It is firstly novel in the device shown that the suction device for the air charged with paint particles 6 indicated by the arrow 9 is located in the interior of the device. The method of construction shown is particularly space-saving in that the band 1 is deflected in a U-shape, whereby the suction aperture 2 of the suction device, not shown, is arranged in the base of the trough 3 thus formed. In this way there is a flow of air along the surface of the band 1. The suction device 2 is located in a wall that is not shown, which delimits the device laterally.

The air charged with paint particles 6 does not arrive directly at the suction aperture 2, but is steered in a wave-form manner around metallic rollers 4. In particular when these rollers 4 are earthed and the paint particles 6 are electrically charged, the paint particles 6 are deposited upon the rollers 4. In this way they do not end up at the filtering, or even none at all.

In order that increasing amounts of residues do not collect on the rollers 4, the rollers 4 are either continuously pressed onto the band 1, and rotate with it, or they can be pressed at least intermittently against the band 1. As in the area of the rollers 4, the band 1 has just passed through the cleaning device shown in FIG. 2, it captures most of the particles 6 deposited on the rollers 4 before it arrives in the area behind the workpiece 7, where the major part of the paint passing by the workpiece 7 impacts directly.

In FIG. 3 the application of the device according to the invention is shown in a car paint shop booth 14. In this case the item 7 to be painted is a car. It stands on an air permeable grid through which the air enriched with paint particles 6, shown by the arrow 9, is sucked downwards. The extracted air flow is suctioned into the trough 3 provided with rollers 4, where the paint particles are rolled onto the band 1 and are separated out. To clean the band 1 and to reclaim the separated paint, a removal device 13 is provided, which can be constructed in a manner similar to that shown in FIG. 2.

In the embodiment shown in FIG. 4, the device according to the invention provided at any place in the air extraction channel 15 that leads into a suction device, not shown, replaces the filter previously provided. In this case, two continuously rotating bands are correspondingly arranged, between which a zig-zag shaped channel 16 is configured. By means of the numerous deflections in the channel 16, the paint particles 6 strike the band 1 because of their inertia and remain adhered to it. Removal devices 13 are again provided for cleaning the bands 1. The extracted air 10 being discharged is free from pollutants.

1. Method for cleansing air contaminated with paint particles, wherein paint particles passing by the workpiece to be painted are suctioned by a suction device, characterised in that the flow of suctioned air is guided along the exterior band surface of at least one continuously rotating band, wherein at least some of the paint particles contained in the suctioned air are separated out onto the rotating band.

2. Method according to claim 1, characterised in that the flow of suctioned air is in the longitudinal direction of the band.

3. Method according to claim 1 or 2, characterised in that paint particles passing by the workpiece to be painted are directly captured by the band.

4. Method according to one of claims 1 to 3, characterised in that the continuously rotating band passes through a removal device for the paint captured, in which the paint is preferably scraped off.

5. Method according to claim 4 and 5, characterised in that separation onto the band occurs at a place that lies behind the removal device and in front of the place where the paint particles are directly captured.

6. Device for implementing the method according to one of claims 1 to 5, characterised in that the suction device is arranged downstream behind the area of the continuous band (1) separating the paint particles (6) from the air.

7. Device according to claim 6, characterised in that the continuous band (1) is provided with an area in which it is deflected in an approximately U-shaped manner, and in that the suction aperture (2) of the suction device is arranged in the base of the trough (3) formed by the deflection.

8. Device according to claims 6 and 7, characterised in that in the flow of extracted air leading to the suction device, there is arranged at least one roller (4) upon the surface of which paint particles (6) can be deposited.

9. Device according to claim 8, characterised in that the surface of the roller (4) can be pressed against the exterior of the rotating band (1).

10. Device according to claim 8 or 9, characterised in that the roller (4) is provided with an electrical earth, and in that a device is provided for electrostatic charging of the paint particles carried by the suctioned air

11. Device according to one of claims 8 to 10, characterised in that the roller (4) is driven independently of the band (1).

12. Device according to one of claims 8 to 11, characterised in that several rollers (4) are arranged offset from one another, around which the flow of extracted air flows in a wave-form manner.

13. Device according to claim 6 or 7, characterised in that the band (1) is deflected at least once in the area in which the paint particles (6) are separated out.

14. Device according to claim 13, characterised in that the band (1) is configured in a zig-zag manner in the area in which the paint particles (6) are separated out.

15. Use of the method according to one of claims 1 to 5 or the device according to one of claims 6 to 14 in a car paint shop booth (14).
